(19) United States
(12) Patent Application Publication
(10) Pub. No.: US 2024/0345501 A1
(43) Pub. Date: Oct. 17, 2024

(54) EXPOSURE APPARATUS AND IMAGE-FORMING APPARATUS

(71) Applicant: CANON KABUSHIKI KAISHA, Tokyo (JP)

(72) Inventor: YASUTOMO FURUTA, Chiba (JP)

(21) Appl. No.: 18/629,454

(22) Filed: Apr. 8, 2024

(30) Foreign Application Priority Data
Apr. 13, 2023 (JP) 2023-065901

(51) Int. Cl. G03G 15/04

(52) U.S. Cl. CPC G03G 15/04036; G03G 2215/0409

(57) ABSTRACT

There is provided an exposure apparatus for exposing a photosensitive body. The exposure apparatus includes light-emitting chips arranged along a first direction parallel to an axial direction of the photosensitive body. Each of the light-emitting chips includes: K current sources; and light-emitting elements arranged in the first direction and grouped into K light-emitting element groups. Light-emitting elements belonging to a k-th light-emitting element group are supplied with electric current from a k-th current source, where k=1, 2, . . . , K. For every one light-emitting element group out of the K light-emitting element groups, a width occupied in the first direction by the one light-emitting element group is larger than a lower limit value corresponding to a spatial frequency at which contrast sensitivity of human vision represented by a visual transfer function peaks.

### BACKGROUND OF THE DISCLOSURE

### Field of the Disclosure

The present disclosure relates to an exposure apparatus and an image-forming apparatus.

### Description of the Related Art

As a type of electrophotographic image-forming apparatus, an apparatus that uses a solid-state exposure method, in which a latent image is formed by exposing a photosensitive drum with light emitted by LEDs (e.g., organic EL elements) instead of laser light, is commonly known. An exposure head of this type of apparatus includes a light-emitting element array that includes a plurality of light-emitting elements arranged parallel with an axial direction of the photosensitive drum, and a rod lens array that focuses light from the light-emitting element array on a surface of the photosensitive drum. The length of the light-emitting element array in the axial direction corresponds to the maximum width of an image to be formed on a surface of the photosensitive drum. The pitch of the light-emitting elements in the light-emitting element array corresponds to the maximum resolution of the image. For example, the pitch of the light-emitting elements in the light-emitting element array in an apparatus capable of forming an image of 1200 dpi is about 21.16 micrometers (m).

The light-emitting element array of an apparatus that uses a solid-state exposure method has, in general, an elongated shape. For example, a light-emitting element array of an exposure apparatus disclosed in Japanese Patent Laid-Open No. 2021-37706 includes a plurality of light-emitting chips in a staggered arrangement, and an interconnection from a power supply to each light-emitting element extends in the longitudinal direction of the light-emitting element array.

Also, a non-patent document “Noise Perception in Electro-photography” (R. P. Dooley and R. Shaw, Journal of Applied Photographic Engineering, Vol. 5, No. 4, pp. 190-196, 1979) introduces a visual transfer function (VTF) model, which relates to the influence of unevenness in light amount on image quality that is subjectively perceived through human vision.

The resistance of the interconnection extending in the longitudinal direction in a current supply circuit of the exposure apparatus causes a non-negligible voltage drop in the voltage applied to the light-emitting elements, and this voltage drop may cause an unevenness in light amount. To suppress such a voltage drop, it is conceivable to provide a large number of current sources in a light-emitting chip equipped with a light-emitting element array and shorten the interconnection length from the current sources to the light-emitting elements. However, manufacturing variations between different current sources also cause unevenness in light amount, resulting in image quality degradation, such as image streaks. The degree to which image streaks are noticeable to human vision depends on the spatial frequency of the image streaks. According to the Dooley and Shaw's VTF model introduced by the aforementioned non-patent document, based on the premise of an observation distance of about 300 millimeters (mm), the contrast sensitivity of human vision peaks at a spatial frequency of about 1.0 cycles/mm.

### SUMMARY OF THE DISCLOSURE

In view of the foregoing issue, the present disclosure aims to improve subjective image quality of an image formed using an exposure apparatus.

According to an aspect, there is provided an exposure apparatus for exposing a photosensitive body. The exposure apparatus includes a plurality of light-emitting chips arranged along a first direction parallel to an axial direction of the photosensitive body. Each of the plurality of light-emitting chips includes: K current sources (K is an integer of two or more); and a plurality of light-emitting elements arranged in the first direction and grouped into K light-emitting element groups. Light-emitting elements belonging to a k-th light-emitting element group are supplied with electric current from a k-th current source, where k=1, 2, . . . , K. For every one light-emitting element group out of the K light-emitting element groups, a width occupied in the first direction by the one light-emitting element group is larger than a lower limit value corresponding to a spatial frequency at which contrast sensitivity of human vision represented by a visual transfer function peaks.

Further features of the present disclosure will become apparent from the following description of exemplary embodiments (with reference to the attached drawings).

### BRIEF DESCRIPTION OF THE DRAWINGS

FIG. 1 is a configuration diagram showing a schematic configuration of an image-forming apparatus according to an embodiment.

FIG. 2A is a first illustrative diagram showing a configuration of a photosensitive member and an exposure head according to an embodiment.

FIG. 2B is a second illustrative diagram showing a configuration of the photosensitive member and the exposure head according to an embodiment.

FIG. 3A is a first illustrative diagram showing a configuration of a printed circuit board of the exposure head according to an embodiment.

FIG. 3B is a second illustrative diagram showing a configuration of the printed circuit board of the exposure head according to an embodiment.

FIG. 4 is an illustrative diagram regarding light-emitting chips and light-emitting element arrays in the light-emitting chips according to an embodiment.

FIG. 5 is a plan view of a schematic configuration of the light-emitting chip according to an embodiment.

FIG. 6 is a cross-sectional view of a schematic configuration of the light-emitting chip according to an embodiment.

FIG. 7 is a circuit diagram showing a control configuration of an exposure apparatus according to an embodiment.

FIG. 8 is a signal chart related to access to a register of the light-emitting chip according to an embodiment.

FIG. 9 is a signal chart related to transmission of image data to the light-emitting chip according to an embodiment.

FIG. 10 is a functional block diagram showing a detailed configuration of the light-emitting chip according to an embodiment.

FIG. 11 is an illustrative diagram regarding multiple exposure performed with light-emitting elements arranged in a staircase pattern.

FIG. 12A is an illustrative diagram regarding a procedure of light emission control based on input image data.

FIG. 12B is an illustrative diagram regarding the procedure of light emission control based on input image data.

FIG. 12C is an illustrative diagram regarding the procedure of light emission control based on input image data.

FIG. 12D is an illustrative diagram regarding the procedure of light emission control based on input image data.

FIG. 13 is a graph of contrast sensitivity according to the Dooley and Shaw's VTF model.

FIG. 14 is a block diagram showing a first example of a configuration of a current supply circuit of the light-emitting chip.

FIG. 15 is an illustrative diagram regarding a width occupied in a first direction by a two-dimensional array of the light-emitting elements in each light-emitting element group.

FIG. 16 is a block diagram showing a second example of the configuration of the current supply circuit of the light-emitting chip.

### DESCRIPTION OF THE EMBODIMENTS

Hereinafter, embodiments will be described in detail with reference to the attached drawings. Note, the following embodiments are not intended to limit the scope of the present disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### 1. Schematic Configuration of Image-Forming Apparatus

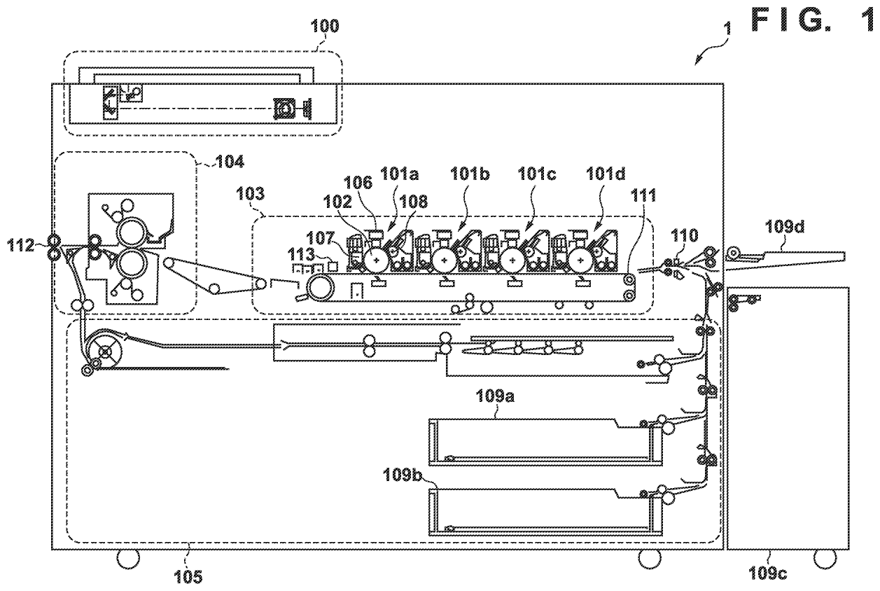

FIG. 1 shows an example of a schematic configuration of an image-forming apparatus 1 according to an embodiment. The image-forming apparatus 1 includes a reading unit 100, an image-making unit 103, a fixing unit 104, and a transport unit 105. The reading unit 100 optically reads an original placed on a platen and generates read image data. The image-making unit 103 forms an image on a sheet based on the read image data generated by the reading unit 100 or based on print image data received from an external device via a network, for example.

The image-making unit 103 includes image-forming units 101a, 101b, 101c, and 101d. The image-forming units 101a, 101b, 101c, and 101d form toner images in black, yellow, magenta, and cyan, respectively. The image-forming units 101a, 101b, 101c and 101d have the same configuration, and are also referred to collectively as image-forming units 101 below. A photosensitive member 102 of each image-forming unit 101 is driven to rotate in the clockwise direction in the figure during image formation. A charger 107 electrically charges a corresponding photosensitive member 102. An exposure head 106 exposes a corresponding photosensitive member 102 with light in accordance with image data to form an electrostatic latent image on a surface of the photosensitive member 102. A developer 108 develops the electrostatic latent image on the surface of the photosensitive member 102 with toner to form a toner image. The toner image formed on the surface of the photosensitive member 102 is transferred to a sheet that is being transported on a transfer belt 111. A color image containing four color components, namely black, yellow, magenta, and cyan can be formed by transferring the toner images of the four photosensitive members 102 to the sheet in a superimposed manner.

The transport unit 105 controls feed and transport of sheets. Specifically, the transport unit 105 feeds a sheet from a unit designated from among internal storage units 109a and 109b, an external storage unit 109c, and a manual feed unit 109d to a transport path in the image-forming apparatus 1. The fed sheet is transported to a registration roller 110. The registration roller 110 transfers the sheet onto the transfer belt 111 at an appropriate timing such that the toner image of each photosensitive member 102 is transferred to the sheet. As mentioned above, the toner images are transferred to the sheet while the sheet is transported on the transfer belt 111. The fixing unit 104 fixes the toner images to the sheet by heating and pressurizing the sheet to which the toner images have been transferred. After the toner images have been fixed, the sheet is discharged to outside the image-forming apparatus 1 by a discharge roller 112. An optical sensor 113 is located at a position facing the transfer belt 111 in a downstream stage of the image forming unit 101a. The optical sensor 113 is used to detect a misalignment (color misalignment) between color components in a test image formed on the transfer belt 111 by the image-forming units 101. If a color misalignment is detected, the image-forming positions of the image-forming units 101a, 101b, 101c, and 101d are corrected so as to compensate for the detected color misalignment under the control of a below-described image controller 700.

Although an example in which the toner image is directly transferred from each photosensitive member 102 to the sheet on the transfer belt 111 has been described here, the toner image may alternatively be transferred indirectly from each photosensitive member 102 to the sheet via an intermediate transfer member. Further, although an example of forming a color image using toner of multiple colors has been described here, the technology according to the present disclosure is also applicable to an image-forming apparatus that forms a monochrome image using toner of a single color.

### 2. Configuration Example of Exposure Head

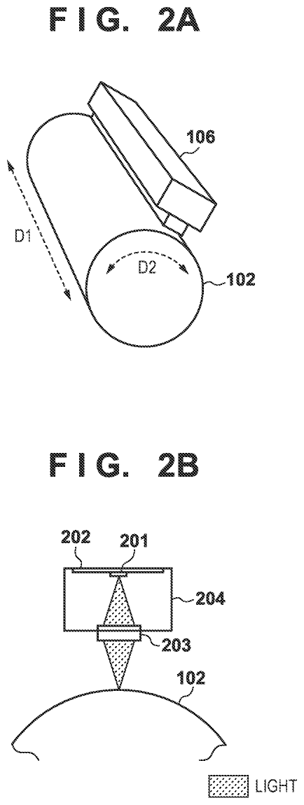

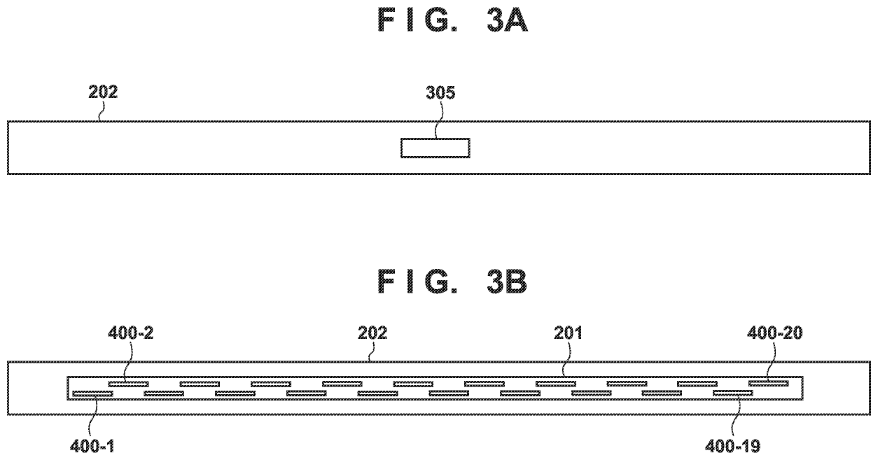

FIGS. 2A and 2B show the photosensitive member 102 and the exposure head 106. As mentioned above, the exposure head 106 is an exposure apparatus that exposes the photosensitive member 102 with light in accordance with image data. The exposure head 106 includes a light-emitting element array 201, a printed circuit board 202 on which the light-emitting element array 201 is mounted, a rod lens array 203, and a housing 204 supporting the printed circuit board 202 and the rod lens array 203. The photosensitive member 102 has a cylindrical shape. The exposure head 106 is located such that the longitudinal direction thereof is parallel with a direction of a rotation axis (first direction D1) of the photosensitive member 102, and a face of the exposure head 106 to which the rod lens array 203 is attached faces the surface of the photosensitive member 102. While the photosensitive member 102 rotates about the rotation axis in a circumferential direction (second direction D2), the light-emitting element array 201 of the exposure head 106 emits light, and the rod lens array 203 forms an image on the surface of the photosensitive member 102 with the emitted light.

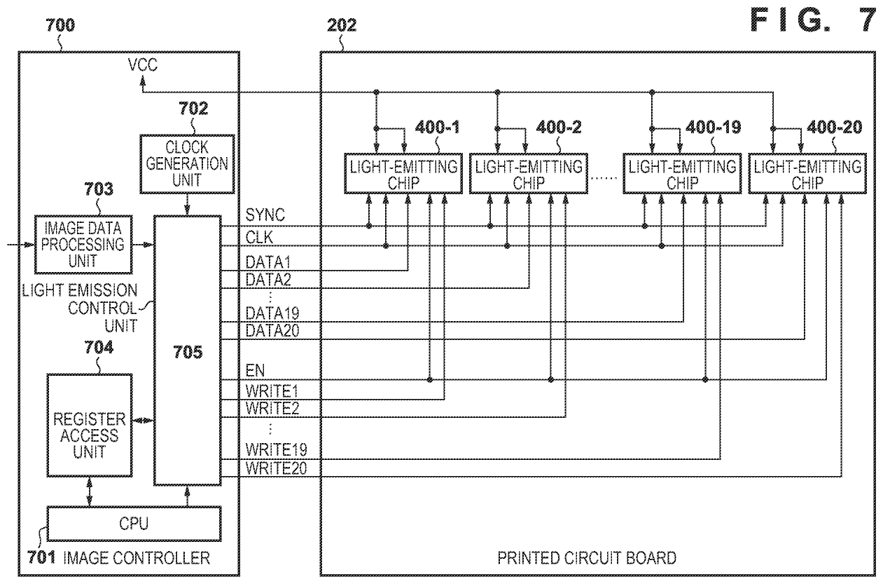

FIGS. 3A and 3B show an example of a configuration of the printed circuit board 202. Note that FIG. 3A shows a face on which a connector 305 is mounted, and FIG. 3B shows a side on which the light-emitting element array 201 is mounted (a face on the side opposite to the face on which the connector 305 is mounted). The light-emitting element array 201 in the present embodiment is constituted by twenty light-emitting chips 400-1 to 400-20, which are regularly arranged in the longitudinal direction. The light-emitting chips 400-1 to 400-20 in the example in FIG. 3B are in a staggered arrangement along the longitudinal direction of the printed circuit board 202 of the exposure head 106. More specifically, ten light-emitting chips 400-n with n being odd numbers form one line, and another ten light-emitting chips 400-n with n being even numbers form another one line. In this specification, the light-emitting chips 400 in the former line are also referred to as odd-numbered light-emitting chips 400, and the light-emitting chips 400 in the latter line are also referred to as even-numbered light-emitting chips 400. The light-emitting chips 400-1 to 400-20 are also referred to collectively as light-emitting chips 400. Each light-emitting chip 400 on the printed circuit board 202 is connected to the image controller 700 (FIG. 7) via the connector 305. In the following, there are cases where the smaller branch number side of the light-emitting chips 400-1 to 400-20 arranged in the first direction D1 is referred to as “left” and the larger branch number side as “right”, for convenience of description. For example, the light-emitting chip 400-1 is a light-emitting chip 400 at the left end, and the light-emitting chip 400-20 is a light-emitting chip at the right end.

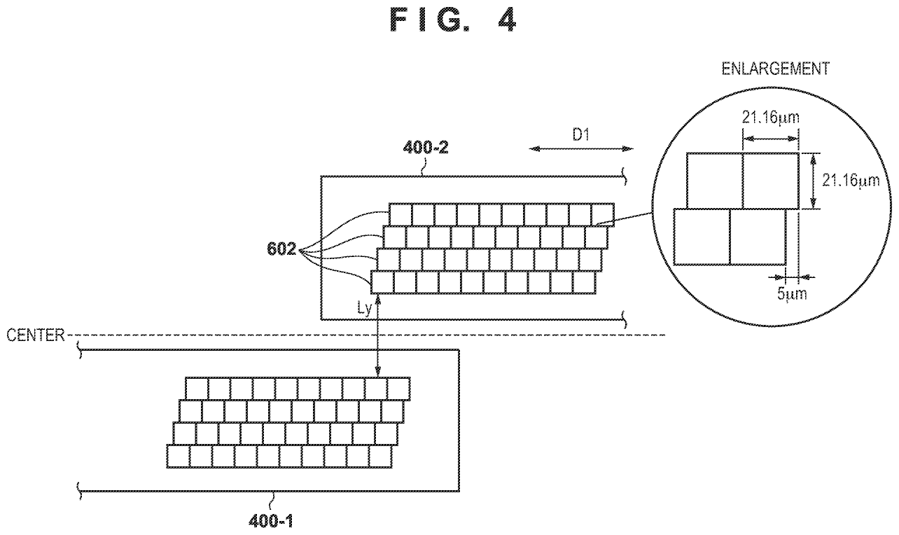

FIG. 4 is an illustrative diagram showing an example of the arrangement of light-emitting elements 602 in the light-emitting chips 400. Each light-emitting chip 400 in the present embodiment includes a two-dimensional array of light-emitting elements in M rows (M is an integer of two or more) in the second direction D2 orthogonal to the first direction D1 and N columns (N is an integer of two or more) in the first direction D1 (note that FIG. 4 shows only a part of the array). In one example, N may be 748 and M may be 4; in this case, each light-emitting chip 400 has a total of 2992 (=748×4) light-emitting elements 602. In the entire light-emitting element array that includes twenty light-emitting chips 400, 14960 light-emitting elements are arranged in the first direction D1. The pitch of light-emitting elements 602 adjoining in the first direction D1 may be approximately 21.16 μm in correspondence with a resolution of 1200 dpi. In this case, the length of the entire light-emitting element array in the first direction D1 is approximately 316 mm (maximum width of a formable image), and the length of each light-emitting chip 400 in the first direction D1 is approximately 15.8 mm. The M light-emitting elements in the respective columns are shifted from each other in the first direction D1 by a shift amount of 5 μm, which corresponds to a resolution of 4800 dpi, and arranged in a staircase pattern. FIG. 4 shows an example in which the lower light-emitting elements, of the two upper and lower light-emitting elements, is shifted to the left, but the lower light-emitting element may alternatively be shifted to the right. Further, the light-emitting elements in the right-end column of an odd-numbered light-emitting chip 400 and the light-emitting elements in the left-end column of an even-numbered light-emitting chip 400 may overlap with each other in the first direction D1, as shown in FIG. 4. Similarly, the light-emitting elements in the left-end column of an odd-numbered light-emitting chip 400 and the light-emitting elements in the right-end column of an even-numbered light-emitting chip 400 may also overlap with each other in the first direction D1. The spacing Ly between light-emitting element arrays in these light-emitting chips 400 may be, for example, about 105 μm. By thus arranging the light-emitting element arrays to overlap with each other in the first direction D1, it is possible to avoid a situation in which implementation variation results in voids within an exposable range. When such an overlapping arrangement is employed, ordinarily, the light-emitting elements in only one of the overlapping columns are used as effective light-emitting elements that may emit light in accordance with image data. The light-emitting elements in the other column need not be used regardless of image data. Note that the number of columns or light-emitting elements overlapping in the first direction D1 is not limited to the above example, but may be any number.

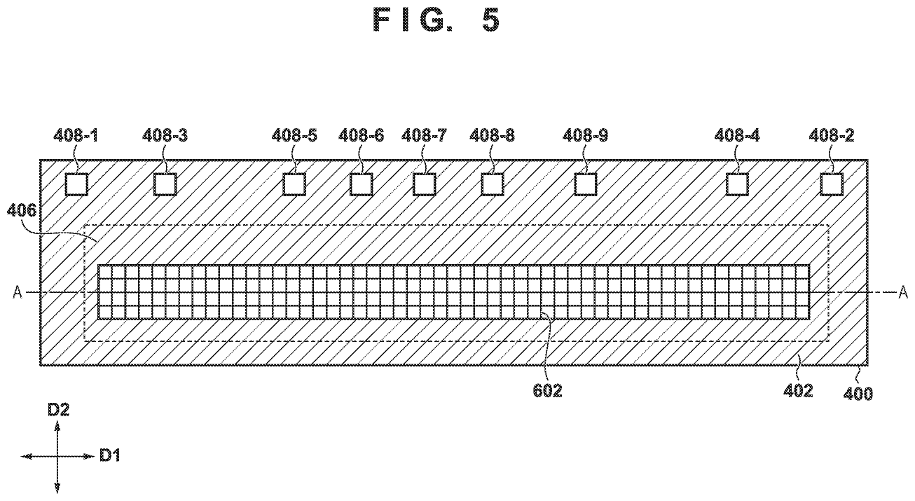

FIG. 5 is a plan view of a schematic configuration of the light-emitting chip 400. The plurality of light-emitting elements 602 of each light-emitting chip 400 are formed on a light-emitting substrate 402, which is a silicon substrate, for example. The light-emitting substrate 402 has a circuit section 406 for driving the plurality of light-emitting elements 602. Pads 408-1 to 408-9 are connected to signal lines for communicating with the image controller 700, power lines for connection with power supplies, and ground lines for connection with ground. The signal lines, the power lines, and the ground lines may be gold wires, for example.

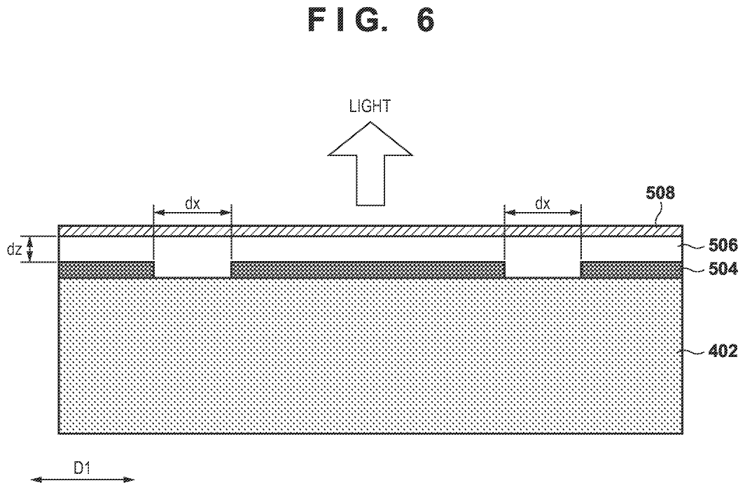

FIG. 6 shows a portion of a cross-section of FIG. 5 taken along a line A-A. A plurality of lower electrodes 504 are formed on the light-emitting substrate 402. Alight-emitting layer 506 is provided on the lower electrodes 504, and an upper electrode 508 is provided on the light-emitting layer 506. The upper electrode 508 is one common electrode for the plurality of lower electrodes 504. When a voltage is applied between the lower electrodes 504 and the upper electrode 508, the light-emitting layer 506 emits light as a result of electric current flowing from the lower electrodes 504 to the upper electrode 508. Thus, one lower electrode 504 and partial regions of the light-emitting layer 506 and the upper electrode 508 that correspond to the lower electrode 504 constitute one light-emitting element 602. “dx” in the figure indicates the spacing between two adjoining lower electrodes 504. “dz” indicates the spacing between the lower electrodes 504 and the upper electrode 508. Making dx larger than dz can suppress a leakage current between adjoining lower electrodes 504 and prevent a light-emitting element 602 that should not emit light from accidentally emitting light.

In the present embodiment, the light-emitting elements 602 are configured as organic electro-luminescence (EL) elements. For example, an organic EL film can be used as the light-emitting layer 506. In another embodiment, the light-emitting elements 602 may be configured as inorganic EL elements by using an inorganic EL film as the light-emitting layer 506. Generally, the light-emitting element 602 may be any type of light-emitting diodes (LEDs).

The upper electrode 508 is constituted by a transparent electrode made of indium tin oxide (ITO) or the like so as to allow the light-emission wavelength of the light-emitting layer 506 to be transmitted. In the example in FIG. 6, the entire upper electrode 508 allows the emission wavelength of the light-emitting layer 506 to be transmitted, but the entire upper electrode 508 need not necessarily allow the light-emission wavelength of the light-emitting layer 506 to be transmitted. Specifically, it is sufficient that a partial region through which light from each light-emitting element 602 passes allows the emission wavelength to be transmitted.

Unevenness in light amount caused by the structure of the light-emitting element can be reduced by seamlessly and continuously forming the light-emitting layer 506 and the upper electrode 508 as in the example in FIG. 6. However, the structure of the light-emitting element is not limited to this example. For example, a plurality of light-emitting layers 506 each having a width equal to the width of a corresponding lower electrode 504 may alternatively be formed on the respective lower electrodes 504. Further, in FIG. 6, the upper electrode 508 is formed as one common electrode for the plurality of lower electrodes 504; however, a plurality of upper electrodes 508 each having a width equal to the width of a corresponding lower electrode 504 may alternatively be formed in correspondence with the respective lower electrodes 504. Further, a first plurality of lower electrodes 504, out of the lower electrodes 504 of each light-emitting chip 400, may be covered by a first light-emitting layer 506, and a second plurality of lower electrodes 504 may be covered by a second light-emitting layer 506. Similarly, a first upper electrode 508 may be formed in common for a first plurality of lower electrodes 504, out of the lower electrodes 504 of each light-emitting chip 400, and a second upper electrode 508 may be formed in common for a second plurality of lower electrodes 504. With such a configuration as well, one lower electrode 504 and regions of the light-emitting layer 506 and the upper electrode 508 that correspond to the lower electrode 504 constitute one light-emitting element 602.

FIG. 7 is circuit diagram related to a control configuration for controlling the light-emitting chips 400. The image controller 700 is a control circuit that communicates with the printed circuit board 202 via a plurality of signal lines (wires). The image controller 700 includes a CPU 701, a clock generation unit 702, an image data processing unit 703, a register access unit 704, and a light emission control unit 705. The light emission control unit 705 terminates the signal lines connected to the printed circuit board 202. An n-th light-emitting chip 400-n (n is an integer from 1 to 20) on the printed circuit board 202 is connected to the light emission control unit 705 via a signal line DATAn and a signal line WRITEn. The signal line DATAn is used to transmit image data from the image controller 700 to the light-emitting chip 400-n. The signal line WRITEn is used by the image controller 700 to write control data to a register of the light-emitting chip 400-n.

One signal line CLK, one signal line SYNC, and one signal line EN are also provided between the light emission control unit 705 and each light-emitting chip 400. The signal line CLK is used to transmit a clock signal for data transmission over the signal lines DATAn and WRITEn. The light emission control unit 705 outputs, to the signal line CLK, a clock signal generated based on a reference clock signal from the clock generation unit 702. Signals transmitted to the signal line SYNC and the signal line EN will be described below.

The CPU 701 controls the entire image-forming apparatus 1. An image data processing unit 703 performs image processing on image data received from the reading unit 100 or an external device, and generates image data in a binary bitmap format for performing control to turn on and off light emission of the light-emitting elements 602 of the light-emitting chips 400 on the printed circuit board 202. Image processing here may include, for example, raster conversion, gradation correction, color conversion, and halftoning. The image data processing unit 703 transmits the generated image data as input image data to the light emission control unit 705. The register access unit 704 writes and reads data to and from the register of each light-emitting chip 400 via the light emission control unit 705.

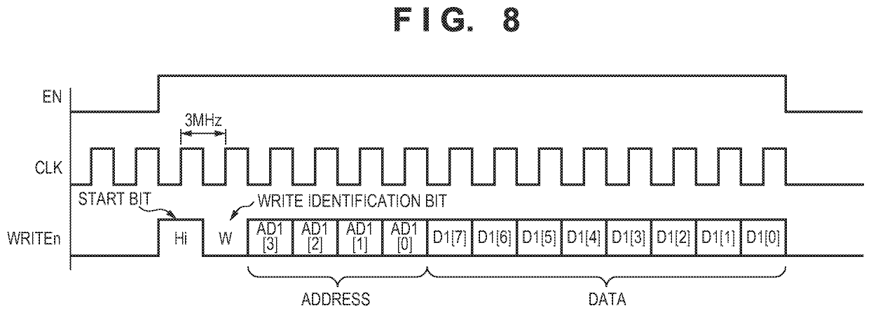

FIG. 8 shows transition of the signal level on each signal line when writing control data to the register of the light-emitting chip 400. An enable signal, which is at high level during communication, indicating that communication is in progress, is output to the signal line EN. The light emission control unit 705 transmits a start bit to the signal line WRITEn synchronously with the rise of the enable signal. Next, the light emission control unit 705 transmits a write identification bit indicating a write operation, and thereafter transmits an address (four bits in this example) of the register to which control data is to be written, and the control data (eight bits in this example). The light emission control unit 705 sets the frequency of the clock signal transmitted to the signal line CLK to, for example, 3 MHz when writing to the register.

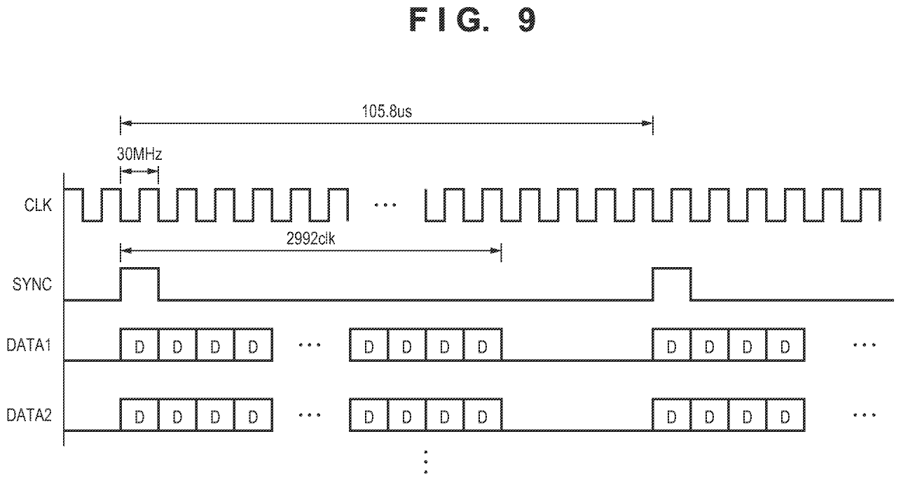

FIG. 9 shows transition of the signal level on each signal line when image data is transmitted to each light-emitting chip 400. A periodic line synchronization signal, which indicates an exposure timing for each line in the photosensitive body 102, is output to the signal line SYNC. When the circumferential velocity of the photosensitive body 102 is 200 mm/s and the resolution in the circumferential direction is 1200 dpi (about 21.16 μm), the line synchronization signal is output at a period of about 105.8 μs. The light emission control unit 705 transmits image data to the signal lines DATA1 to DATA20 synchronously with the rise of the line synchronization signal. Since each light-emitting chip 400 in the present embodiment has 2992 light-emitting elements 602, image data indicating whether or not to cause each of the 2992 light-emitting elements 602 to emit light needs to be transmitted to each light-emitting chip 400 within a period of about 105.8 μs. Therefore, in this example, the light emission control unit 705 sets the frequency of the clock signal transmitted to the signal line CLK to 30 MHz when transmitting the image data, as shown in FIG. 9.

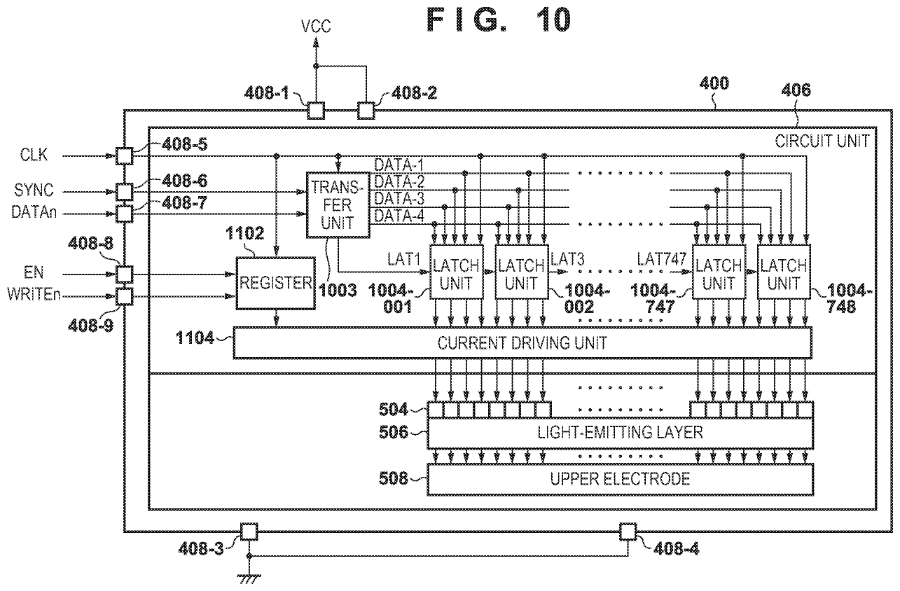

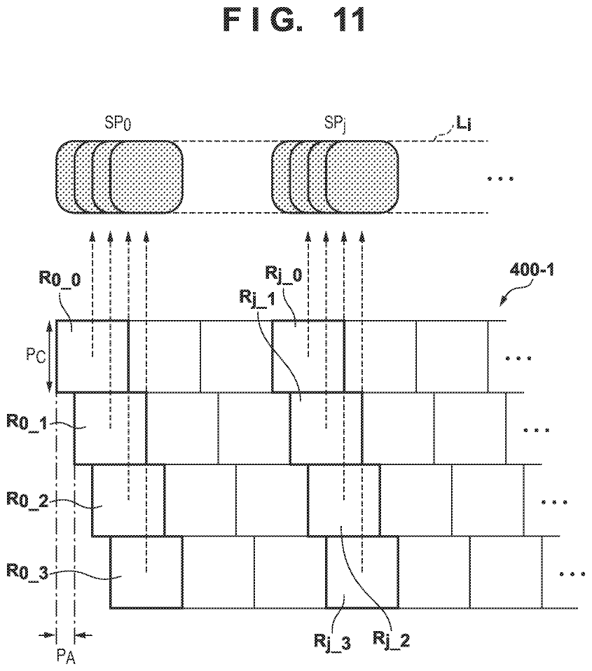

FIG. 10 is a functional block diagram showing a detailed configuration of one light-emitting chip 400 (n-th light-emitting chip 400-n). Each light-emitting chip 400 has nine pads 408-1 to 408-9, as also shown in FIG. 5. The pads 408-1 and 408-2 are connected to a power supply voltage VCC through a power line. Power from this power supply voltage VCC is supplied to each circuit of the circuit section 406 of the light-emitting chip 400. The pads 408-3 and 408-4 are connected to a ground through a ground line. Each circuit of the circuit section 406 and the upper electrode 508 are connected to a ground via the pads 408-3 and 408-4. The signal line CLK is connected to a transfer unit 1003, a register 1102, and latch units 1004-001 to 1004-748 via the pad 408-5. The signal lines SYNC and DATAn are connected to the transfer unit 1003 via the pads 408-6 and 408-7. The signal lines EN and WRITEn are connected to the register 1102 via the pads 408-8 and 408-9. Control data indicating, for example, a below-described current adjustment amount (or current amount) is stored in the register 1102.

Starting from the line synchronization signal from the signal line SYNC, the transfer unit 1003 receives, from the signal line DATAn, input image data that includes a series of pixel values indicating whether or not to cause each one of the light-emitting elements 602 to emit light, synchronously with the clock signal from the signal line CLK. The transfer unit 1003 performs serial-to-parallel conversion in units of M (e.g., M=4) pixel values for the series of pixel values received serially from the signal line DATAn. For example, the transfer unit 1003 has four cascaded D flip-flops, and outputs the pixel values DATA-1, DATA-2, DATA-3, and DATA-4 that are input over four clocks to the latch units 1004-0001 to 1004-748 in parallel. The transfer unit 1003 also has another four D flip-flops for delaying the line synchronization signal, and outputs a first latch signal to the latch unit 1004-001 via a signal line LAT1 at a timing delayed for four clocks after the line synchronization signal is input.

An n-th latch unit 1004-n (n is an integer from 1 to 748) holds, using a latch circuit, the four pixel values DATA-1, DATA-2, DATA-3, and DATA-4 that are input from the transfer unit 1003 simultaneously with the input of an n-th latch signal. The n-th latch unit 1004-n, except for the last latch unit 1004-748, delays the n-th latch signal for four clocks and outputs an (n+1)-th latch signal to a latch unit 1004-(n+1) via a signal line LAT(n+1). The n-th latch unit 1004-n continues to output drive signals based on the four pixel values held by the latch circuit to a current drive unit 1104 during the signal period of the n-th latch signal. For example, there is a delay for four clocks between the timing when the first latch signal is input to the latch unit 1004-1 and the timing when the second latch signal is input to the latch unit 1004-2. Therefore, the latch unit 1004-1 outputs drive signals based on the first, second, third, and fourth pixel values to the current drive unit 1104, while the latch unit 1004-2 outputs drive signals based on the fifth, sixth, seventh, and eighth pixel values to the current drive unit 1104. In short, the latch unit 1004-n outputs drive signals based on the (4n-3)-th, (4n-2)-th, (4n-1)-th, and (4n)-th pixel values to the current drive unit 1104. Therefore, in the embodiment shown in FIG. 10, the 748 latch units 1004-001 to 1004-748 transmit, substantially in parallel, 2992 drive signals for controlling driving of 2992 (=748×4) light-emitting elements 602 to the current drive unit 1104. Each drive signal is a binary signal that indicates high or low level.

The current drive unit 1104 has 2992 light-emitting drive circuits corresponding to 2992 light-emitting elements 602, each including a partial region of the light-emitting layer 506. Each light-emitting drive circuit applies a drive voltage corresponding to the current amount indicated by control data in the register 1102 to the light-emitting layer 506 of the corresponding the light-emitting element 602 while the corresponding drive signal is at high level, i.e., indicates turning on light emission. As a result, electric current flows through the light-emitting layer 506, and the light-emitting element 602 emits light.

### 3. Multiple Exposure Control

In the present embodiment, the M light-emitting elements 602 in each column may be arranged in a staircase pattern at a fixed pitch, as described with reference to FIG. 4. FIG. 11 is an illustrative diagram regarding multiple exposure performed with light-emitting elements arranged in a staircase pattern. Here, an example of an arrangement of light-emitting elements when M=4 is shown. R_{j_m}(j={0, 1, . . . , N-1}, m={0, 1, 2, 3}) in the figure represents a light-emitting element 602 in a j-th column from the left and an m-th row from the top. The pitch P_{C} of the light-emitting elements in the second direction D2 may be about 21.16 μm, as mentioned above. A spacing P_{A} in the first direction D1 between two adjacent light-emitting elements, of the M light-emitting elements in each column, may be about 5 μm, as mentioned above.

Due to four light-emitting elements in each column being arranged in a staircase pattern as in the example in FIG. 11, any two adjoining light-emitting elements among those four light-emitting elements occupy partially overlapping areas in the first direction D1. The four light-emitting elements in a column corresponding to each pixel position on input image data successively emit light while the photosensitive member 102 rotates, thereby forming a spot corresponding to the pixel position on the surface of the photosensitive member 102. In the example in FIG. 11, when the pixel value at the left end of an i-th line of input image data indicates that light emission is on, light-emitting elements R_{0_0}, R_{0_1}, R_{0_2}, and R_{0_3} successively emit light at timings at which the respective light-emitting elements face a line Lᵢ on the surface of the photosensitive member 102. As a result, the spot region at the left end of the line Lᵢ is subjected to multiple exposure, and a corresponding spot SP₀ is formed. Similarly, when a j-th pixel value from the left end of the i-th line of the input image data indicates that light emission is on, light-emitting elements R_{j_0}, R_{j_1}, R_{j_2}, and R_{j_3} successively emit light at timings at which the respective light-emitting elements face the line Lᵢ on the surface of the photosensitive member 102. As a result, a j-th spot region from the left end of the line Lᵢ is subjected to multiple exposure, and a corresponding spot SPⱼ is formed. Thus, as a result of four light-emitting elements in each column of twenty light-emitting chips 400 successively emitting light at appropriate timings, a smooth line of an electrostatic latent image that is constituted by a series of spots with a constant spot spacing that partially overlap with each other may be formed on the surface of photosensitive member 102. A two-dimensional electrostatic latent image is produced as a result of such lines being continuously formed in the circumferential direction.

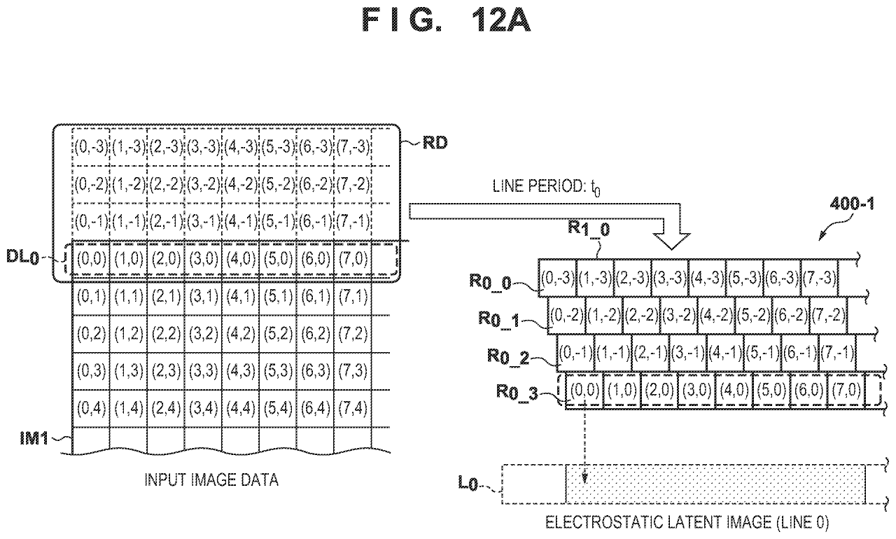

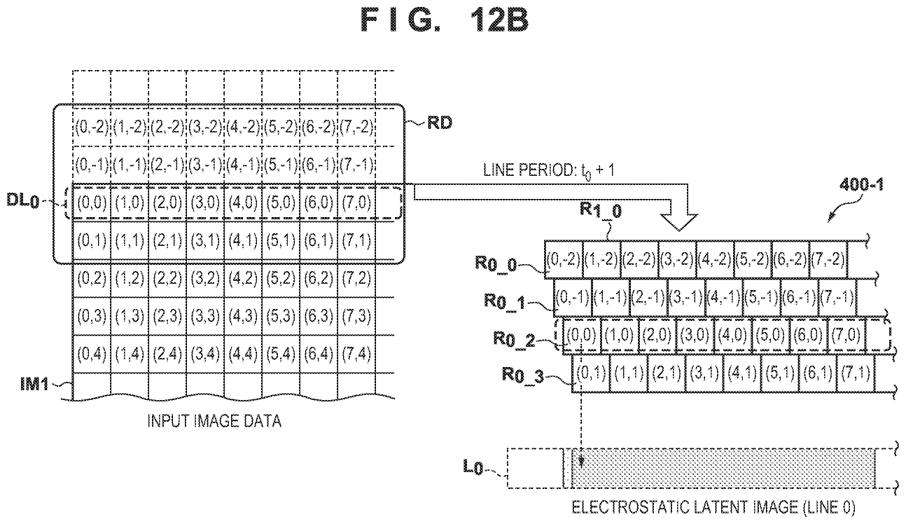

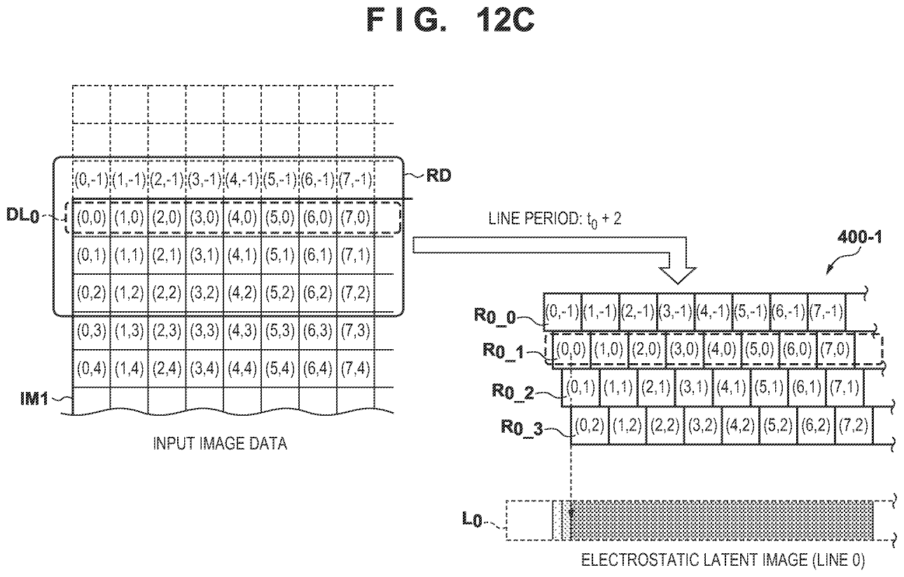

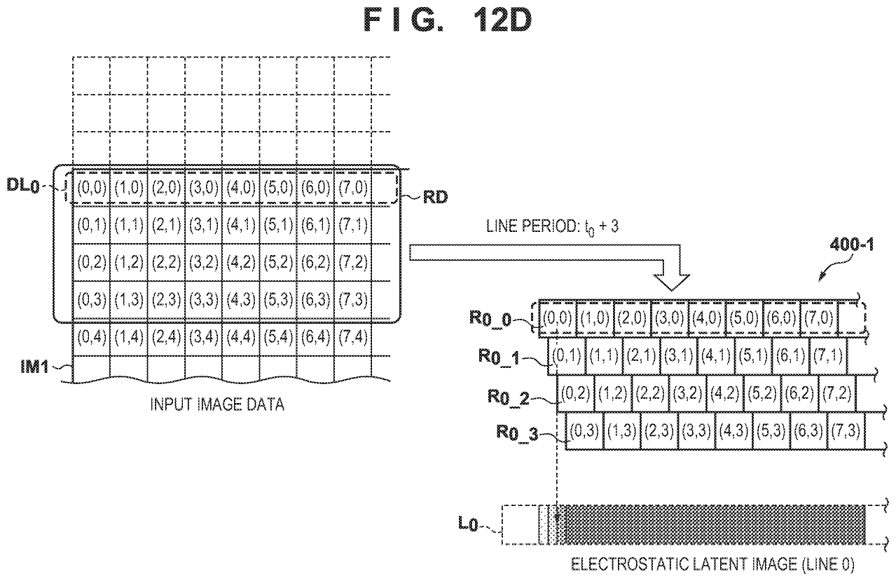

FIGS. 12A to 12D are illustrative diagrams regarding a procedure of light emission control based on input image data. When forming an image, the light emission control unit 705 receives input image data IM1 in a binary bitmap format from the image data processing unit 703. In the left diagram in FIG. 12A, a j-th pixel value from the left in an i-th line from the top of the input image data IM1, which is a two-dimensional pixel value array, is expressed as (j, i) (j={0, 1, 2, . . . }, i={0, 1, 2, . . . }). The light emission control unit 705 adds dummy pixel values equivalent to (M-1) lines to the head of the input image data IM1. If M=4, the range of a pixel value index i including the added dummy pixel values is {−3, −2, −1, 0, 1, 2, . . . }. The dummy pixel values may be, for example, zero, which means turning off light emission. The light emission control unit 705 may also add dummy pixel values to the left and right of the input image data IM1 such that the number of pixel values per line is equal to the number of light-emitting elements in the first direction D1, but here, only effective pixel values are shown with respect to the first direction D1 for simplicity of description.

In a first line period t₀ of image formation, the light emission control unit 705 reads pixel values for four lines from the top of the input image data IM1, and outputs a subset per every 2992 (=748×4) read pixel values to the light-emitting chip 400-n via the signal line DATAn. Focusing on the light-emitting chip 400-1 shown in the right diagram of FIG. 12A, image data in a read range RD including pixel values from (0, −3) to (748, 0) is input via the signal line DATA1 during the line period t₀. The light-emitting chip 400-1 performs serial-to-parallel conversion on the input image data and supplies drive signals based on these pixel values to 2992 light-emitting elements, respectively. For example, drive signals based on pixel values (0, −3), (0, −2), (0, −1), (0, 0), and (1, −3) are supplied to the light-emitting elements R_{0_0}, R_{0_1}, R_{0_2}, R_{0_3}, and R_{1_0}, respectively. In particular, drive signals based on effective pixel values in a line DL₀ with an index i=0 in the input image data IM1 are supplied to the light-emitting elements in the fourth row that include the light-emitting element R_{0_3}, as indicated by a broken line in the figure. As a result, a line L₀ on the surface of the photosensitive body 102 is exposed in accordance with a pixel value set for the line DL₀ in the input image data IM1. However, at this point, multiple exposure is still in progress, and the formation of the line L₀ in an electrostatic latent image is not completed.

FIG. 12B shows driving of the light-emitting chip 400-1 during the next line period t₀+1. In the line period t₀+1, the light emission control unit 705 moves the read range RD of the input image data IM1 downward by one line, reads pixel values from (0, −2) to (748, 1), and outputs the read pixel values to the light-emitting chip 400-1 via the signal line DATA1. The light-emitting chip 400-1 supplies drive signals based on the input pixel values to the 2992 light-emitting elements. For example, drive signals based on pixel values (0, −2), (0, −1), (0, 0), (0, 1), and (1, −2) are supplied to the light-emitting elements R_{0_0}, R_{0_1}, R_{0_2}, R_{0_3}, and R_{1_0}, respectively. In the line period t₀+1, drive signal based on effective pixel values in a line DL₀ in the input image data IM1 are supplied to the light-emitting elements in the third row that includes the light-emitting element R_{0_2}. At this time, since the photosensitive body 102 is rotating in the circumferential direction, the line L₀ on the surface of the photosensitive body 102 faces the light-emitting elements in the third row of the light-emitting chip 400-1. As a result, the line L₀ on the surface of the photosensitive body 102 is exposed again in accordance with the pixel value set for the line DL₀ in the input image data IM1.

FIG. 12C shows driving of the light-emitting chip 400-1 during the next line period t₀+2. In the line period t₀+2, the light emission control unit 705 moves the read range RD of the input image data IM1 further downward by one line, reads pixel values from (0, −1) to (748, 2), and outputs the read pixel values to the light-emitting chip 400-1 via the signal line DATA1. The light-emitting chip 400-1 supplies drive signals based on the input pixel values to the 2992 light-emitting elements. In the line period t₀+2, drive signals based on effective pixel values in the line DL₀ in the input image data IM1 are supplied to the light-emitting elements in the second row that include the light-emitting element R_{0_1}. At this time, the line L₀ on the surface of the photosensitive body 102 faces the light-emitting elements in the second row of the light-emitting chip 400-1. As a result, the line L₀ on the surface of the photosensitive body 102 is exposed for the third time in accordance with the pixel value set for the line DL₀ in the input image data IM1.

FIG. 12D shows driving of the light-emitting chip 400-1 during the next line period t₀+3. In the line period t₀+3, the light emission control unit 705 moves the read range RD of the input image data IM1 further downward by one line, reads pixel values from (0, 0) to (748, 3), and outputs the read pixel values to the light-emitting chip 400-1 via the signal line DATA1. The light-emitting chip 400-1 supplies drive signals based on the input pixel values to the 2992 light-emitting elements. In the line period t₀+3, drive signals based on effective pixel values in the line DL₀ in the input image data IM1 are supplied to the light-emitting elements in the first row including the light-emitting element R_{0_0}. At this time, the line L₀ on the surface of the photosensitive body 102 faces the light-emitting elements in the first row of the light-emitting chip 400-1. As a result, a line L₀ on the surface of the photosensitive body 102 is exposed for the fourth time in accordance with a pixel value set for the line DL₀ in the input image data IM1. At this point, multiple exposure by four light-emitting elements in each column of the light-emitting chip 400 has been performed, and the formation of the line L₀ of the electrostatic latent image is completed. Lines subsequent to the line L₀ of the electrostatic latent image may also be formed similarly on the surface of the photosensitive body 102 through repetition of the above-described line periods.

Thus, in the present embodiment, a drive signal based on a pixel value at each pixel position is input to four light-emitting elements in a corresponding column of the light-emitting element array. Specifically, for example, a drive signal based on the pixel value (0, 0) is input to the four light-emitting elements R_{0_3}, R_{0_2}, R_{0_1}, and R_{0_0}. When these four light-emitting elements emit light in accordance with the drive signal, a spot corresponding to the pixel value (0, 0) is formed on the surface of the photosensitive body 102. Similarly, a drive signal based on the pixel value (1, 0) is input to the four light-emitting elements R_{1_3}, R_{1_2}, R_{1_1}, and R_{1_0}. When these four light-emitting elements emit light in accordance with the drive signal, a spot corresponding to the pixel value (1, 0) is formed on the surface of the photosensitive body 102.

As understood from the above description, the light emission control unit 705 causes a plurality of light-emitting elements 602 to emit light based on the pixel values read from the read range corresponding to M lines in the input image data IM1. The read range moves by one line per line period.

### 4. Improvement of Subjective Image Quality

### 4-1. Basic Principle

The light-emitting element array in each light-emitting chip 400 has a shape elongated in the first direction D1, as described above. If only one current source for supplying power to the light-emitting elements is provided in each light-emitting chip 400, the interconnection resistance between the current source and the light-emitting elements causes a non-negligible voltage drop in the voltage applied to light-emitting elements that are far from the current source.

In the present embodiment, K current sources (K is an integer of two or more) are provided in each light-emitting chip 400. Also, the light-emitting elements in the light-emitting element array in each light-emitting chip 400 is grouped into K light-emitting element groups. Then, a current supply circuit is designed so as to supply a current from a k-th current source to light-emitting elements belonging to a k-th light-emitting element group, with k=1, 2, . . . , K. By setting the number K of current sources (equal to the number of light-emitting element groups) to a sufficiently large value, the interconnection length from the current sources to the light-emitting elements can be shortened, and the voltage drop caused by interconnection resistance can be suppressed.

Here, a limit is placed on the width occupied in the first direction D1 by one light-emitting element group in order to prevent noticeable image quality degradation perceived by human vision from being caused by manufacturing variations in the current sources and related circuit sections. Typically, manufacturing variations in the current sources and the related circuit sections cause a cyclic unevenness in light amount with the width of the light-emitting element group as a cycle, and the effect of the unevenness in light amount appears as image streaks in a printed image. The degree to which image streaks are noticeable to human vision depends on the spatial frequency of the image streaks.

The Dooley and Shaw's VTF model represents contrast sensitivity of human vision, which depends on the spatial frequency, by a VTF function expressed by the following equation.

$$VTF = 5.05 {e}^{- 0.138 v} ( 1 - {e}^{- 0.1 v} ) , v = \frac{π i λ}{180} \qquad [ Math 1 ]$$

Here, λ denotes the spatial frequency.

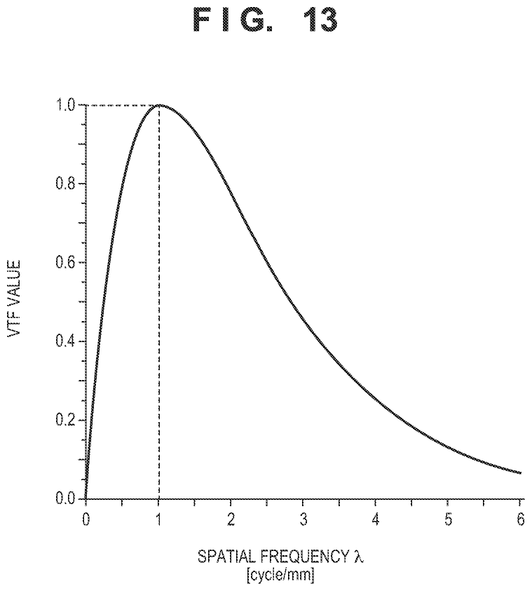

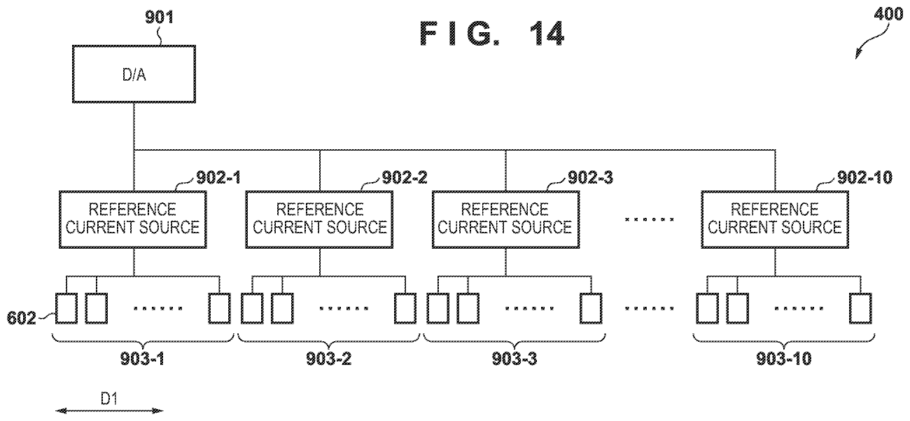

FIG. 13 is a graph of contrast sensitivity according to the Dooley and Shaw's VTF model, with an observation distance L of 300 mm. The horizontal axis of the graph indicates the spatial frequency λ [cycle/mm], and the vertical axis indicates the output value (sensitivity intensity) of the VTF function. As seen in the graph in FIG. 13, based on the premise that the observation distance L=300 mm, the contrast sensitivity of human vision peaks at a spatial frequency of about 1.0 cycles/mm. This spatial frequency corresponds to the cycle of an image streak of about 1 mm. That is, an image streak can be most strongly perceived as degradation of subjective image quality when the width of the image streak is equal to 1 mm.

Increasing the number K of current sources (i.e., increasing the density of the current sources) can make the width of the image streak narrower than 1 mm (i.e., increase the spatial frequency) and make it possible to avoid the aforementioned peak of the contrast sensitivity. However, the inventor recognized that high-frequency image streaks caused other types of image quality degradation, such as moiré, due to interference with a dot screen. Therefore, in order to avoid a peak of contrast sensitivity and improve image quality, it is meaningful to arrange the current sources such that the spatial frequency of image streaks comes to the left side (low-frequency side) of the peak of the contrast sensitivity, instead of the right side (high-frequency side).

Based on the above concept, the arrangement of the current sources in each light-emitting chip 400 is designed so as to satisfy the following condition 1.
Condition 1: For every one of the K light-emitting element groups, the width W_{G} occupied in the first direction D1 by the one light-emitting element group is larger than a lower limit value corresponding to the spatial frequency at which the contrast sensitivity of human vision peaks.

The lower limit value here may be different depending on the observation distance L as the premise, but may be, for example, 1 mm, with the premise that the observation distance L is 300 mm based on the general applications of printed images. Alternatively, setting the lower limit value to 1.5 mm makes it possible to significantly lower the contrast sensitivity from the peak and further suppress degradation of subjective image quality.

Further, the arrangement of the current sources in each light-emitting chip 400 may be designed so as to also satisfy the following condition 2.
Condition 2: For every one of the K light-emitting element groups, the width W_{G} occupied in the first direction D1 by the one light-emitting element group is smaller than an upper limit value corresponding to the tolerance of a voltage drop in the current supply from the current sources to the light-emitting elements.

The upper limit value here may vary depending on the characteristics of the current supply circuit and the target value of the current amount, but may be, for example, 4 mm. Alternatively, setting the upper limit value to 2 mm can further reduce the voltage drop.

### 4-2. First Example

Several examples of the design of the current supply circuit that satisfies the conditions 1 and 2 are described below.

In the first example, in the first direction D1, the number of columns of the light-emitting elements in the entire light-emitting element array 201 is 14960, and the pitch of the light-emitting elements is about 21.16 μm, which corresponds to the resolution of 1200 dpi, as described above. This makes it possible to form an image with a maximum width of about 316 mm in the first direction D1. When the light-emitting element array 201 includes twenty light-emitting chips 400-1 to 400-20, the width of the light-emitting element array in each light-emitting chip 400 is about 15.8 mm, and the number of columns of the light-emitting elements is 748. Therefore, the width W_{G} per group can be set to about 1.58 mm on average by, for example, dividing the two-dimensional light-emitting element array in each light-emitting chip 400 into 10 light-emitting element groups (i.e, K=10).

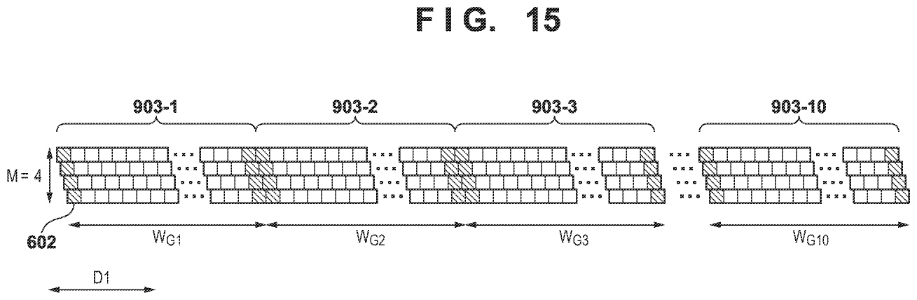

FIG. 14 shows the first example of the configuration of the current supply circuit of the light-emitting chip 400. Referring to FIG. 14, the light-emitting chip 400 includes a digital-to-analog converter (D/A) 901, ten reference current sources 902-1 to 902-10, and a plurality of light-emitting elements 602 that are grouped into ten light-emitting element groups 903-1 to 903-10. Each light-emitting element 602 belongs to any one of the light-emitting element groups 903-1 to 903-10 depending on the position of the light-emitting element 602 in the first direction D1.

The D/A 901 performs digital-to-analog conversion on a digital value of the current amount indicated by control data read from the aforementioned register, and outputs an analog signal having a voltage corresponding to the current amount to each reference current source 902. The current amount here may be, for example, the sum of a predetermined reference amount (common to a plurality of light-emitting chips 400) and an adjustment amount that is predetermined for each light-emitting chip 400. In this case, the D/A 901 acts as a current adjustment circuit. A voltage drop in this part of the interconnection can be prevented by transmitting the current amount from the D/A 901 to each reference current source 902 using an analog signal that is a voltage signal. Each reference current source 902 applies a drive voltage to each light-emitting element 602 in accordance with the analog signal input from the D/A 901 at the timing when the drive signal described with reference to FIG. 10 is at high level, and supplies electric current for emitting light at a target light emission intensity to each light-emitting element 602.

Once again, the number of columns of the light-emitting elements in the first direction D1 of the light-emitting chip 400 is 748. In the first example, given that the number of light-emitting element groups K=10, the number of columns of the light-emitting elements belonging to each light-emitting element group 903 may be, for example, as follows:
Light-emitting element groups 903-1 to 903-9: 75 columns per group
Light-emitting element groups to 903-10: 73 columns

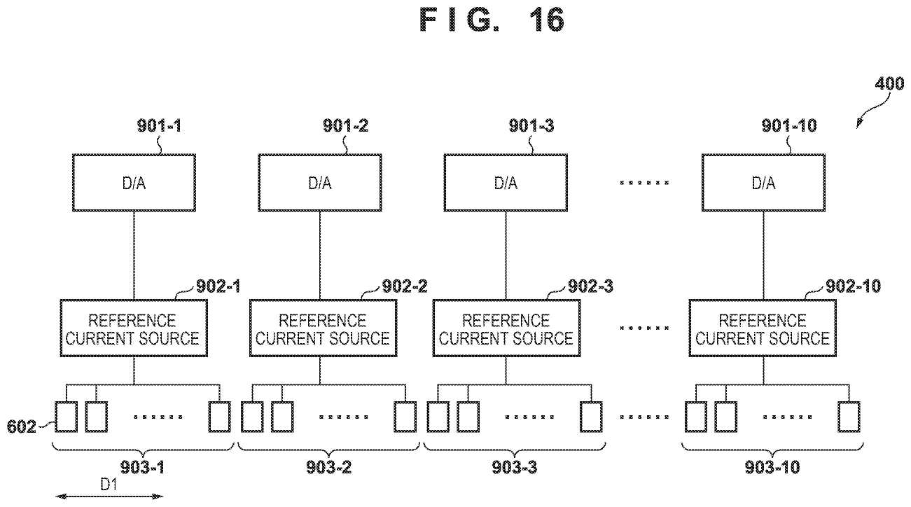

FIG. 15 is an illustrative diagram regarding the width W_{G} occupied in the first direction D1 by the two-dimensional array of the light-emitting elements in each light-emitting element group 903. In the first example, the light-emitting elements belonging to each of the K light-emitting element groups 903 are arranged continuously in the first direction D1. This configuration optimizes the length of the interconnection from each reference current source 902 to the corresponding light-emitting elements 602. The width W_{Gk} occupied in the first direction D1 by the k-th light-emitting element group 903-k corresponds to the widest spacing in the first direction D1 between two of the light-emitting elements belonging to the light-emitting element group 903-k, that is, between the light-emitting elements located at the respective ends. In FIG. 15, the light-emitting elements located at both ends of each light-emitting element group 903 are shaded.

The width W_{G1} of the first light-emitting element group 903-1 is equal to about 1.587 mm, which is the product of the number of columns (K=75) and the pitch (about 21.16 μm). The same applies to the width W_{G2} of the second light-emitting element group 903-2 and the width W_{G3} of the third light-emitting element group 903-3. The width W_{G10} of the tenth light-emitting element group 903-10 is equal to about 1.545 mm, which is the product of the number of columns (K=73) and the pitch (about 21.16 μm). Thus, all of the widths W_{G1} to W_{G10} satisfy the above conditions 1 and 2. Therefore, subjective image quality can be improved by avoiding a peak of the contrast sensitivity of human vision without causing interference moiré, while suppressing a voltage drop and reducing unevenness in light amount.

Naturally, the number of reference current sources 902 (the number of light-emitting element groups) K included in each light-emitting chip 400 is not limited to the above example. For example, more (or fewer) light-emitting chips 400 may be installed in the exposure head 106, and each light-emitting chip 400 may include fewer (or more) reference current sources 902 accordingly.

### 4-3. Second Example

In the second example as well, the number of columns of the light-emitting elements in the entire light-emitting element array 201 is 14960, the pitch of the light-emitting elements is about 21.16 μm, the number of light-emitting chips 400 installed in the exposure head 106 is 20, and the number of light-emitting element groups 903 is 10 (K=10). Therefore, the W_{G} occupied in the first direction D1 by one light-emitting element group is about 1.58 mm on average.

FIG. 16 shows the second example of the configuration of the current supply circuit of the light-emitting chip 400. Referring to FIG. 16, the light-emitting chip 400 includes ten D/As 901-1 to 901-10, ten reference current sources 902-1 to 902-10, and a plurality of light-emitting elements 602 that are grouped into ten light-emitting element groups 903-1 to 903-10. Each light-emitting element 602 belongs to any one of the light-emitting element groups 903-1 to 903-10 depending on the position of the light-emitting element 602 in the first direction D1.

A k-th (k=1, . . . , 10) D/A 901-k is connected to a k-th reference current source 902-k. The D/A 901-k performs digital-to-analog conversion on a digital value of the current amount for the k-th reference current source 902-k that is indicated by control data read from the aforementioned register, and outputs an analog signal having a voltage corresponding to the current amount to the reference current source 902-k. The current amount here is, for example, the sum of a predetermined reference amount and an adjustment amount that is predetermined for each reference current source 902. That is, each D/A 901 acts as a current adjustment circuit. The k-th reference current source 902-k applies a drive voltage to the light-emitting elements 602 belonging to the k-th light-emitting element group 903-k at the timing when the drive signal described with reference to FIG. 10 is at high level, and supplies electric current for emitting light at a target light emission intensity to each light-emitting element 602.

The current adjustment amount for each reference current source 902 may be predetermined based on the results of measuring the amount of light emitted from the light-emitting element array at the stage of manufacturing or testing the exposure head 106. For example, a fixed current amount is supplied from the reference current sources 902-1 to 902-10 to the corresponding light-emitting elements 602, and the distribution of the light amount that is resultantly emitted from the light-emitting element array indicates an unevenness in light amount due to manufacturing errors. Based on these results of measuring the light amount, the current adjustment amount for each reference current source 902 (e.g., an offset for compensating for the difference between the target light amount and the measured light amount) is determined such that the amounts of light emitted from the K light-emitting element groups are uniform. The control data written to the register of each light-emitting chip 400 may indicate the thus-determined adjustment amounts. When the exposure head 106 is powered on, the CPU 701 reads the control data from the register of each light-emitting chip 400 and sets the adjustment amounts (or the current amounts) to respective D/As 901. The D/As 901-1 to 901-10 in the second example adjust the current amounts supplied from the reference current sources 902-1 to 902-10 to the corresponding light-emitting elements in accordance with the setting.

In this example as well, as a result of the current supply circuit being designed so as to satisfy the above conditions 1 and 2, it is possible to reduce unevenness in light amount by suppressing a voltage drop, and to improve subjective image quality by avoiding a peak of the contrast sensitivity in human vision.

Note that the light amount distribution may be measured by reading, using a scanner, a test pattern formed on a sheet by the image-forming apparatus 1, instead of being measured using a light amount measuring device at the stage of manufacturing or testing the exposure head 106. In one modification, a scanner (reading device) that optically reads a test pattern formed on a sheet by the image-forming apparatus 1 may be connected to a downstream section of the image-forming apparatus 1. Further, the current adjustment amount for each reference current source 902 may be automatically determined by analyzing the read image of the test pattern (e.g., using the image controller 700). Instead, the user who views the test pattern on the sheet may specify the current adjustment amount for each reference current source 902 via a user interface.

Although some specific numerical values related to the light-emitting element array have been described herein, the present disclosure is not limited to these specific numerical values. The number of light-emitting chips provided on one printed circuit board is not limited to twenty, and may be any number that is one or more. The size of the light-emitting element array in each light-emitting chip 400 is not limited to four rows×748 columns, and may be any other size. The pitch of the light-emitting elements is not limited to about 21.16 μm, and may take any other value.

### 5. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-065901, filed on Apr. 13, 2023 which is hereby incorporated by reference herein in its entirety.

What is claimed is:

1. An exposure apparatus for exposing a photosensitive body, the exposure apparatus comprising:
a plurality of light-emitting chips arranged along a first direction parallel to an axial direction of the photosensitive body,
wherein each of the plurality of light-emitting chips includes:
K current sources (K is an integer of two or more); and
a plurality of light-emitting elements arranged in the first direction and grouped into K light-emitting element groups, light-emitting elements belonging to a k-th light-emitting element group being supplied with electric current from a k-th current source, where k=1, 2, . . . , K, and
for every one light-emitting element group out of the K light-emitting element groups, a width occupied in the first direction by the one light-emitting element group is larger than a lower limit value corresponding to a spatial frequency at which contrast sensitivity of human vision represented by a visual transfer function peaks.

2. The exposure apparatus according to claim 1,
wherein the visual transfer function is the Dooley and Shaw's VTF function represented by a following expression:
$$VTF = 5.05 {e}^{- 0.138 v} ( 1 - {e}^{- 0.1 v} ) , v = \frac{π i λ}{180} \qquad [ Math 2 ]$$
where λ denotes a spatial frequency.

3. The exposure apparatus according to claim 2, wherein the lower limit value is one millimeter.

4. The exposure apparatus according to claim 1,
wherein, for every one light-emitting element group out of the K light-emitting element groups, the width occupied in the first direction by the one light-emitting element group is smaller than an upper limit value corresponding to a tolerance of a voltage drop in electric current supply from the current sources to the light-emitting elements.

5. The exposure apparatus according to claim 4, wherein the upper limit value is four millimeters.

6. The exposure apparatus according to claim 1,
wherein each of the plurality of light-emitting chips includes a two-dimensional array of light-emitting elements in M rows (M is an integer of two or more) in a second direction orthogonal to the first direction and N columns (N is an integer of two or more) in the first direction, and
the width occupied in the first direction by the one light-emitting element group corresponds to a spacing in the first direction between two light-emitting elements having a widest spacing in the first direction among the light-emitting elements belonging to the one light-emitting element group.

7. The exposure apparatus according to claim 1,
wherein each of the plurality of light-emitting chips further includes:
K adjustment circuits configured to adjust respective amounts of electric current supplied from the K current sources such that amounts of light emitted from the K light-emitting element groups are uniform.

8. An image-forming apparatus comprising:
a photosensitive body; and
an image exposure apparatus for exposing the photosensitive body, the exposure apparatus comprising:
a plurality of light-emitting chips arranged along a first direction parallel to an axial direction of the photosensitive body,
wherein each of the plurality of light-emitting chips includes:
K current sources (K is an integer of two or more); and
a plurality of light-emitting elements arranged in the first direction and grouped into K light-emitting element groups, light-emitting elements belonging to a k-th light-emitting element group being supplied with electric current from a k-th current source, where k=1, 2, . . . , K, and
for every one light-emitting element group out of the K light-emitting element groups, a width occupied in the first direction by the one light-emitting element group is larger than a lower limit value corresponding to a spatial frequency at which contrast sensitivity of human vision represented by a visual transfer function peaks.
